(19) United States
(12) Patent Application Publication
(10) Pub. No.: US 2004/0242749 A1
(43) Pub. Date: Dec. 2, 2004

(54) Lamp-capping cement for electric lamps

(76) Inventors: Rainer Schirmer, Turkheim (DE); Johann Schoenwetter, Langerringen (DE); Armin Wilhelm, Oberneufnach (DE)

Correspondence Address: OSRAM SYLVANIA INC, 100 ENDICOTT STREET, DANVERS, MA, 01923, US

(21) Appl. No.: 10/487,829

(22) PCT Filed: Sep. 5, 2002
(86) PCT No.: PCT/DE02/03280

(30) Foreign Application Priority Data
Sep. 13, 2001 (DE) 101 45 232.2

(51) Int. Cl. C08K 3/26

(52) U.S. Cl. 524/425

(57) ABSTRACT

The invention relates to a lamp-capping cement for electric lamps that contains poly-paraphenylene-terephthalamide as the thixotropic element. According to the invention, the poly-paraphenylene-terephthalamide is used in lamp-capping elements to adjust viscosity, especially to reduce the fluidity of the cement.

The invention relates to a capping cement for electric lamps in accordance with the preamble of claim 1.

### I. PRIOR ART

A capping cement of this kind is disclosed, for example, in the international patent application bearing the publication number WO 98/43267. The capping cement is normally used to fix the lamp vessel in the cap shell. For this purpose a ring of cement is mounted on the inside of the cap shell, in the vicinity of its rim. Application of the cement and insertion of the lamp vessel into the cap shell take place on different manufacturing equipment, so that the cap shells which have been provided with the cement ring must still be transported for capping. The cap shells provided with the cement ring are often stored for several weeks before being used to cap the lamp vessels. A major problem in cement preparation and in the capping of the lamps is posed by the correct adjustment of the viscosity and swellability of the capping cement. The viscosity of the cement must be adjusted so that during transport or storage of the cement-lined cap shell the cement does not run into the base of the cap shell and block the openings for the current leads.

### II. SUMMARY OF THE INVENTION

The object of the invention is to provide a capping cement for electric lamps whose viscosity can be modified within wide ranges without adversely affecting the swellability of the cement. The particular object of the invention is to provide a capping cement for electric lamps whose fluidity is greatly reduced.

This object of the invention is achieved by the features of claim 1 or by the features of claim 4. Particularly preferred embodiments of the invention are described in the dependent claims.

The capping cement of the invention for electric lamps comprises one or more resins and one or more fillers and also, if desired, solvents and comprises polyparaphenyleneterephthalamide as thixotropic agent. Polyparaphenyleneterephthalamide is also known under the brand name KEVLAR® from DuPont. As a result of the addition of polyparaphenyleneterephthalamide it is possible to vary the viscosity of the capping cement within wide ranges without thereby adversely affecting the swellability of the capping cement. Mechanical insertion of the cement into the cap shell is facilitated by the addition of polyparaphenyleneterephthalamide, since owing to its thixotropic property the cement stiffens immediately following insertion. It is therefore possible to carry out machine processing of cements whose viscosity in the pasted state at rest is particularly low. The greater the fraction of polyparaphenyleneterephthalamide, the lower the fluidity of the capping cement. The fraction of polyparaphenyleneterephthalamide in the capping cement is advantageously from 0.05 percent by weight to 30 percent by weight based on the dry mass of the capping cement, in other words based on the resin component and the filler component of the cement, without taking into account the solvent fraction. Since in comparison to the other components of the capping cement polyparaphenyleneterephthalamide is a relatively costly addition, the amount of polyparaphenyleneterephthalamide used is as small as possible. It has been found that just a relatively low polyparaphenyleneterephthalamide fraction of only 0.3 percent by weight based on the dry mass of the capping cement is sufficient to reduce the fluidity of the capping cement sufficiently, so that during transport or storage of the cement-lined cap shell the cement does not run into the base of the cap shell.

A key advantage of the invention is that polyparaphenyleneterephthalamide can be used as a thixotropic agent in any known capping cement for electric lamps. It is not important whether the capping cement comprises synthetic resins, natural resins or a mixture of these two resin types. Additionally, polyparaphenyleneterephthalamide is compatible with the customary fillers of the known capping cements. Moreover, the known solvents or suspension media such as, for example, ethanol, butanol or water can also be used to form a paste of the capping cement. In each of the known capping cement formulations, the addition of polyparaphenyleneterephthalamide brings about a reduction in the fluidity of the cement. An adverse effect on the swellability of the cement as a result of adding polyparaphenyleneterephthalamide has not been observed in any case.

Preferably, polyparaphenyleneterephthalamide is admixed in powder form to the capping cement in order to ensure the best possible mixing and homogenization with the cement components. It is, however, also possible to use fibrous polyparaphenyleneterephthalamide, provided that the fibres are sufficiently small to allow homogeneous mixing with the cement components without affecting the metering process. The size of the fibres should therefore be adapted to the average particle size of the other cement components, especially the fillers.

### III. DESCRIPTION OF THE PREFERRED EMBODIMENTS

The invention is illustrated below with reference to preferred embodiments.

In accordance with the first preferred embodiment of the invention, the resin component of the capping cement is composed of 8.1 percent by weight of phenolic resin of designation K0791 from Bakelite, 0.7 percent by weight of silicone resin of designation 6-2230 from Dow Corning, 2.5 percent by weight of rosin and 0.8 percent by weight of shellac. The filler component of the capping cement is formed by 74.5 percent of calcite of designation JP/LM from Merkle GmbH and 8.0 percent by weight of calcite of designation Nofacal Z from Bayerische Farben- und Mineralwerke. The particle size, i.e. the D50 value, of the calcite is approximately 200 μm. Solvents used are 1.1 percent by weight of isobutanol and 3.7 percent by weight of ethanol. The capping cement further comprises 0.3 percent by weight of a 1.8 percent strength solution of fuchsine red as dye. In order to reduce the fluidity of the cement, the capping cement further comprises 0.3 percent by weight of polyparaphenyleneterephthalamide.

In accordance with the second preferred embodiment of the invention, each 1000 g of capping cement powder contains 770.0 g of calcspar, 84.5 g of phenolic resin, 84.5 g of silicone resin and 61.0 g of polyvinylbutyral. Added to each 1000 g of this capping cement powder are 3.0 g of high-purity silica, available commercially under the brand name Aerosil®, and 2.4 g of polyparaphenyleneterephthalamide in powder form. Added as solvent to this capping cement powder are at least 75 g of ethanol per 1000 g of capping cement powder.

In accordance with the third preferred embodiment of the invention, each 1000 g of capping cement powder contains 830.2 g of calcspar, 80.0 g of phenolic resin, 12.0 g of silicone resin and 55.2 g of polyvinylbutyral and also 22.6 g of triphenyl phosphate. Added to each 1000 g of this capping cement powder are 3.0 g of high-purity silica, available commercially under the brand name Aerosil®, and 2.4 g of polyparaphenyleneterephthalamide in powder form. Added as solvent to this capping cement powder are at least 50 g of ethanol per 1000 g of capping cement powder.

In accordance with the fourth preferred embodiment of the invention, each 1000 g of capping cement powder contains 852.6 g of calcspar, 83.2 g of phenolic resin, 8.4 g of silicone resin and 55.2 g of polyvinylbutyral and also 22.6 g of triphenyl phosphate. Added to each 1000 g of this capping cement powder are 3.0 g of high-purity silica, available commercially under the brand name Aerosil®, and 3.0 g of polyparaphenyleneterephthalamide in powder form. Added as solvent to this capping cement powder are at least 70 g of ethanol per 1000 g of capping cement powder.

1. Capping cement for electric lamps, comprising one or more resins and one or more fillers and also, where appropriate, solvents, characterized in that the capping cement comprises polyparaphenyleneterephthalamide as thixotropic agent.

2. Capping cement according to claim 1, characterized in that the fraction of the polyparaphenyleneterephthalamide in the capping cement is from 0.05 percent by weight to 30 percent by weight based on the dry mass of the capping cement.

3. Capping cement according to claim 1, characterized in that the fraction of the polyparaphenyleneterephthalamide in the capping cement is less than or equal to 0.3 percent by weight based on the dry mass of the capping cement.

4. Use of polyparaphenyleneterephthalamide for adjusting the viscosity in a capping cement for electric lamps.

5. Use of polyparaphenyleneterephthalamide according to claim 4 in powder form.

6. Capping cement according to claim 2, characterized in that the fraction of the polyparaphenyleneterephthalamide in the capping cement is less than or equal to 0.3 percent by weight based on the dry mass of the capping cement.
